(19) United States
(12) Patent Application Publication
(10) Pub. No.: US 2025/0240385 A1
(43) Pub. Date: Jul. 24, 2025

(54) IMAGING APPARATUS

(71) Applicant: Panasonic Intellectual Property Management Co., Ltd., Osaka (JP)

(72) Inventor: Masakazu YASUNAGA, Osaka (JP)

(73) Assignee: Panasonic Intellectual Property Management Co., Ltd., Osaka (JP)

(21) Appl. No.: 19/021,355

(22) Filed: Jan. 15, 2025

(30) Foreign Application Priority Data
Jan. 22, 2024 (JP) 2024-007508

(51) Int. Cl. H04N 5/77

(52) U.S. Cl. CPC H04N 5/772

(57) ABSTRACT

An imaging apparatus is enabled to stably operate a wireless communication function during access to a recording medium. In a case of performing wireless communication by a wireless communication unit and accessing the recording medium inserted into a slot, a controller selects an antenna to be used from a plurality of antennas by referring to antenna setting information stored in a memory and using category information of the recording medium inserted into the slot. The controller accesses the recording medium while performing wireless communication by the wireless communication unit by using the selected antenna.

### CROSS-REFERENCE TO RELATED APPLICATION

This application claims priority to Japanese patent application No. 2024-007508 filed on Jan. 22, 2024, which is incorporated by reference in its entirety.

### BACKGROUND

The present disclosure relates to an imaging apparatus having a wireless communication function and including a slot that can be loaded with a recording medium.

JP 2019 087921 A discloses a technique capable of realizing high-speed communication in which an influence of noise unevenly distributed in a device is reduced in a case of performing communication using a plurality of antennas. It becomes possible to obtain a noise vector inside the device by performing self-training between the antennas of a reception device, and to obtain an ideal signal from a difference between a signal vector received from a transmission device and the noise vector.

### SUMMARY

The present disclosure enables an imaging apparatus to stably operate a wireless communication function during access to a recording medium.

An imaging apparatus according to the present disclosure includes: a plurality of antennas; a wireless communication unit configured to perform wireless communication by using the plurality of antennas; an imaging sensor configured to capture a subject image to generate image data; a slot into which a recording medium for recording the image data is insertable; a memory configured to store antenna setting information indicating a combination of category information of the recording medium and an antenna to be used; and a controller configured to perform control including wireless communication by the wireless communication unit and access to the recording medium inserted into the slot. In a case of performing wireless communication by the wireless communication unit and accessing the recording medium inserted into the slot, the controller selects an antenna to be used from the plurality of antennas by referring to the antenna setting information stored in the memory and using the category information of the recording medium inserted into the slot, and accesses the recording medium while performing wireless communication by the wireless communication unit by using the selected antenna.

According to the imaging apparatus of the present disclosure, it is possible to stably operate the wireless communication function during access to the recording medium.

### BRIEF DESCRIPTION OF THE DRAWINGS

FIG. 1 is a front view illustrating an appearance of an imaging apparatus according to an embodiment;

FIG. 2 is a diagram conceptually illustrating an internal configuration of the imaging apparatus;

FIG. 3 is an example of antenna setting information;

FIG. 4 is a flowchart indicating an example of an antenna selection operation; and

FIG. 5 is another example of an internal configuration of the imaging apparatus of FIG. 1.

### DETAILED DESCRIPTION

Hereinafter, embodiments will be described in detail with reference to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art. Note that the inventor(s) provides the accompanying drawings and the following description in order for those skilled in the art to fully understand the present disclosure, and does not intend to limit the subject matter described in the claims by the accompanying drawings and the following description.

### Embodiment

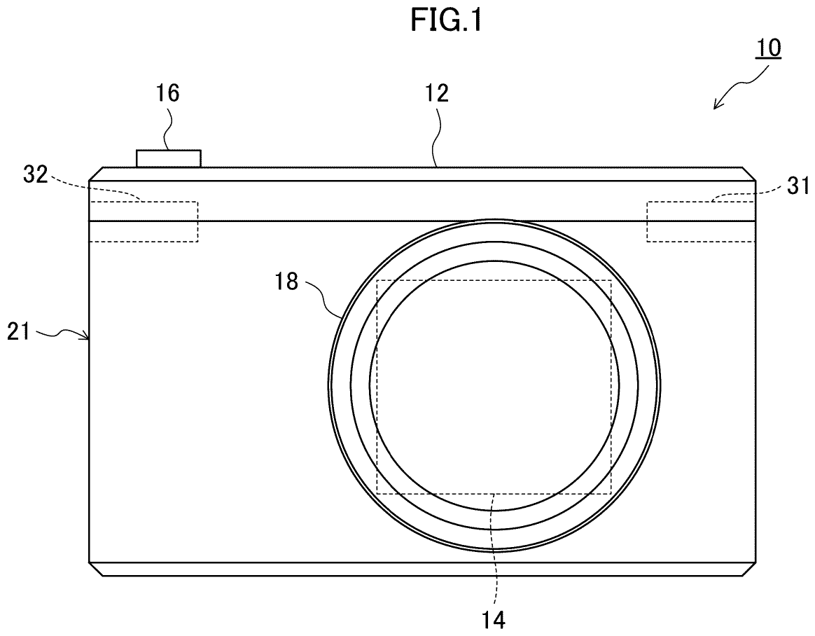

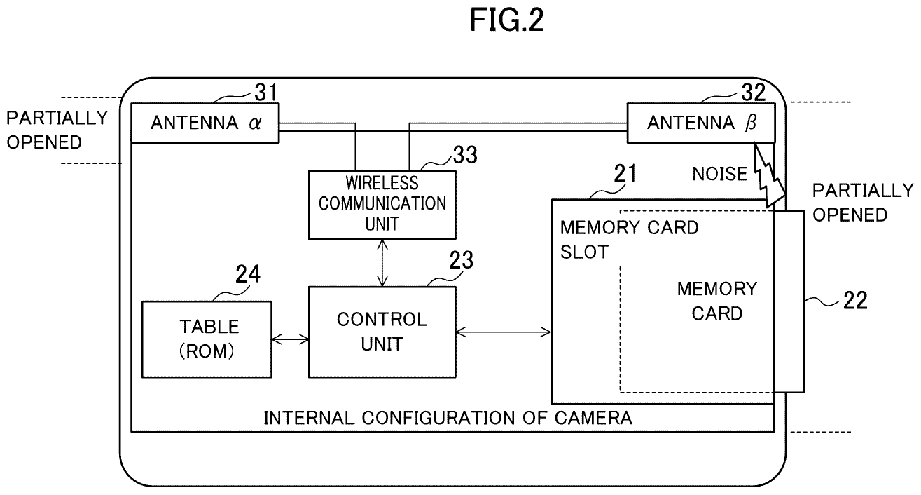

FIG. 1 is a front view illustrating an appearance of an imaging apparatus according to an embodiment of the present disclosure. FIG. 2 is a diagram conceptually illustrating an internal configuration of the imaging apparatus of FIG. 1. FIG. 2 illustrates an image of the imaging apparatus of FIG. 1 as viewed from the back side.

As illustrated in FIG. 1, an imaging apparatus 10 includes a housing (casing) 12 and an imaging element 14 provided in the housing 12. The imaging element 14 constitutes an imaging sensor configured to capture a subject image to generate image data. The housing 12 is made of metal, for example, and has a rectangular shape as viewed in the normal direction of a light receiving surface of the imaging element 14. When viewed from the front of the housing 12, a shutter button 16 is provided at an upper left portion of the housing 12. The imaging apparatus 10 includes a lens 18 provided on a front surface of the housing 12 so as to be located in front of the imaging element 14 and configured to form an image of a subject on the light receiving surface of the imaging element 14.

As illustrated in FIGS. 1 and 2, the imaging apparatus 10 incorporates a memory card slot 21. The memory card slot 21 can be loaded with a memory card 22 which is an example of a recording medium for recording image/video data.

In addition, the imaging apparatus 10 incorporates a plurality of antennas 31 and 32. The antenna 31 (antenna α) and the antenna 32 (antenna β) are provided at distant positions in order to maintain isolation (insulation property). In FIG. 1, when viewed from the front of the housing 12, the antenna 31 is provided near an upper right end portion of the housing 12, and the antenna 32 is provided near an upper left end portion thereof. That is, in the housing 12, as viewed in the normal direction of the light receiving surface of the imaging element 14, the antenna 31 is arranged on one end side and the antenna 32 is arranged on the other end side, in a longitudinal direction of the rectangle housing 12. A distance between the antenna 31 and the memory card slot 21 is longer than a distance between the antenna 32 and the memory card slot 21. The antennas 31 and 32 include, for example, an antenna pattern or an antenna component formed on a mounting surface of a circuit board.

In the housing 12, portions where the antennas 31 and 32 and the memory card slot 21 are arranged are partially opened.

The imaging apparatus 10 includes a controller 23, a table 24 constituted by a read-only memory (ROM), and a wireless communication unit 33. The controller 23 includes, for example, a processor such as a central processing unit (CPU) mounted on the circuit board provided in the housing 12, a storage device such as a memory, and the like. The ROM constituting the table 24 is also mounted on the circuit board. The wireless communication unit 33 performs wireless communication with an external apparatus such as a mobile terminal or a personal computer using the antennas 31 and 32.

The controller 23 performs image/video processing in the imaging apparatus 10. In addition, the controller 23 performs control on each unit including wireless communication by the wireless communication unit 33 and access to the memory card 22 inserted into the memory card slot 21. The table 24 stores antenna setting information indicating a combination of category information of the memory card 22 inserted into the memory card slot 21 and an antenna to be used. An example of the antenna setting information stored in the table 24 will be described later. Note that the imaging apparatus 10 is preferably configured such that the antenna setting information stored in the table 24 can be updated from the outside of the imaging apparatus 10 by wireless communication.

Here, the imaging apparatus, a so-called digital camera, is mainly a metal casing from the viewpoint of designability and robustness. Therefore, in the imaging apparatus 10, the antennas 31 and 32 for wireless communication and the memory card slot 21 are provided inside the housing 12, and opening portions are limited. With such a configuration, the antenna 32 is located in close proximity to the memory card 22.

Meanwhile, due to improvement in image quality of photographing, electromagnetic compatibility (EMC) noise generated at the time of accessing the memory card 22 is increased. For this reason, depending on the type of the memory card 22 loaded into the memory card slot 21, the wireless communication quality is often deteriorated. This is a phenomenon of so-called self-poisoning (intra EMC).

Therefore, in the present disclosure, the controller 23 selects an antenna to be used by using the category information of the memory card 22 in a case of performing wireless communication by the wireless communication unit 33 and accessing the memory card 22 inserted into the memory card slot 21. The antenna setting information stored in the table 24 is referred to for the antenna selection. In the antenna setting information, the antenna to be used is set according to the magnitude of the electromagnetic noise generated by the memory card 22. The controller 23 accesses the memory card 22 while performing wireless communication by the wireless communication unit 33 using the selected antenna.

As a result, noise interference caused by the access to the memory card with respect to wireless communication can be suppressed, so that stable wireless communication in which transmission loss does not occur can be realized. Note that the magnitude of the electromagnetic noise generated by the memory card 22 may be instantaneous or average, and thus the antenna setting information may be created in consideration of these factors as appropriate.

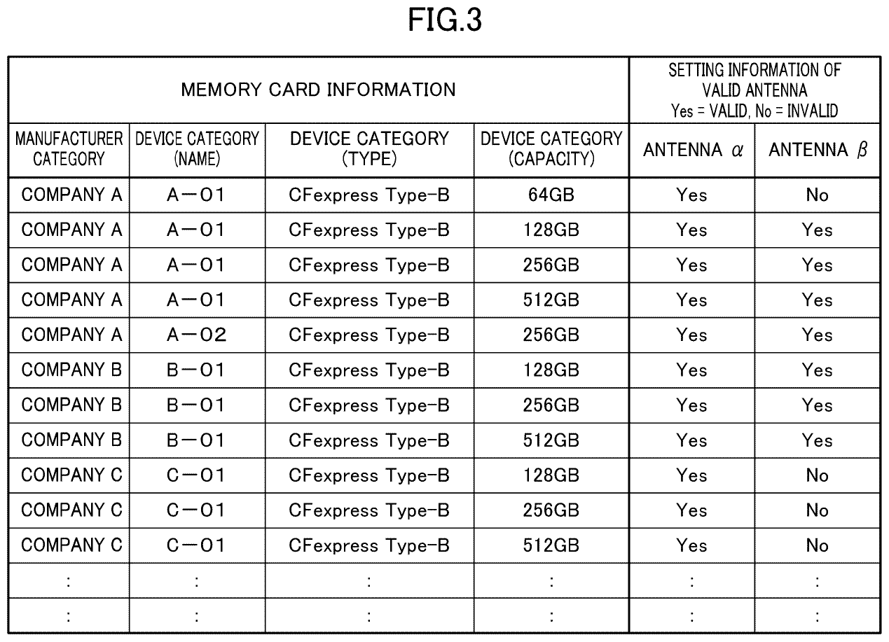

FIG. 3 is an example of the antenna setting information stored in the table 24. In the example of FIG. 3, the relationship between memory card information specifying the memory card and setting information of the valid antenna used when the memory card is loaded is indicated. The memory card information includes a manufacturer category, and a name, a type, and a capacity representing a device category. The setting information of the valid antenna indicates whether the antenna α and the antenna β are valid or invalid. For example, when a memory card, which is manufactured by a company A, has a name “A-01”, is a type “CFexpress Type-B”, and has a capacity of 64 GB, is loaded, the antenna α is valid and the antenna β is invalid. As can be seen from FIG. 3, in a case of making any one of the antennas valid, the antenna α located farther from the memory card 22 becomes valid. Note that when wireless communication is performed by using both the antenna α and the antenna β, multi input multi output (MIMO) communication may be performed.

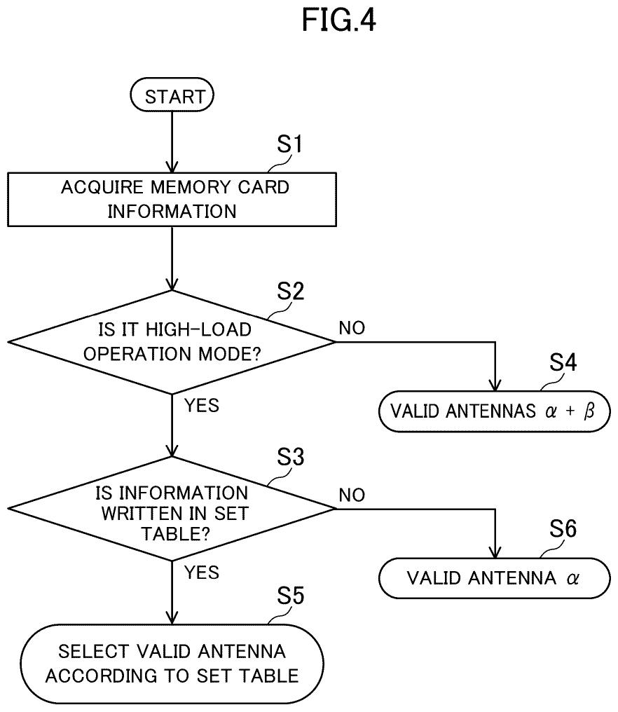

FIG. 4 is a flowchart indicating an example of processing for selecting the valid antenna in the present embodiment. In this example, it is assumed that an antenna to be used is selected by using the category information of the memory card 22 and information of an operation mode of the imaging apparatus 10. Here, information of whether the operation mode is the high-load operation mode (high noise) is used as the information of the operation mode. A time of setting a recording mode at 4K images and a frame rate of 60 is an example of the high-load operation mode.

The processing is started when the memory card 22 is inserted into the memory card slot 21 or when the operation mode of the imaging apparatus 10 is changed. First, in step S1, the controller 23 acquires the memory card information from the memory card 22 inserted into memory card slot 21. The category information of the memory card can be collected by acquiring the memory card information (see FIG. 3). Then, in step S2, it is determined whether the operation mode is the high-load operation mode.

When the operation mode is the high-load operation mode (YES in S2), the controller 23 refers to the table 24 and checks whether the acquired memory card information is written in the stored antenna setting information (S3). When it is written in the stored antenna setting information (YES in S3), the valid antenna is selected according to the setting information of the valid antenna indicated in the memory card information (S5).

On the other hand, when the operation mode is not the high-load operation mode (NO in S2), noise is not considered to be a problem, and thus both the antenna α and the antenna β are selected as valid antennas (S4).

In addition, when the acquired memory card information is not written in the antenna setting information stored in the table 24, it is not clear whether noise is a problem, and thus the antenna α is selected as the valid antenna (S5).

Note that, in the example of FIG. 4, it is assumed that the antenna to be used is selected by using the category information of the memory card 22 and the information of the operation mode of the imaging apparatus 10, and that the information of whether the operation mode is the high-load operation mode is used as the information of the operation mode. However, the present disclosure is not limited thereto. That is, information other than the information of whether the operation mode is the high-load operation mode may be used as the information of the operation mode of the imaging apparatus 10. For example, as will be described later, information of whether the mode is a mode to which an external liquid crystal apparatus is connected may be used as the information of the operation mode of the imaging apparatus 10. In addition, the antenna to be used may be selected using only the category information of the memory card 22 without using the information of the operation mode of the imaging apparatus 10.

As described above, according to the present embodiment, the imaging apparatus 10 includes the plurality of antennas 31 and 32 and the memory card slot 21. In a case of performing wireless communication by the wireless communication unit 33 and accessing the memory card 22 inserted into the memory card slot 21, the controller 23 selects an antenna to be used from the plurality of antennas 31 and 32 by referring to the antenna setting information stored in the table 24 and using the category information of the memory card 22 inserted into the memory card slot 21, and accesses the memory card 22 while performing wireless communication by the wireless communication unit 33 by using the selected antenna. As a result, noise interference caused by the access to the memory card 22 with respect to wireless communication can be suppressed, so that stable wireless communication in which transmission loss does not occur can be realized.

### OTHER EMBODIMENTS

As described above, the above embodiment has been described as an example of the technique disclosed in the present application. However, the technique in the present disclosure is not limited thereto, and can also be applied to embodiments in which changes, replacements, additions, omissions, and the like are made as appropriate. In addition, it is also possible to combine the components described in the above embodiment to form a new embodiment.

In the embodiment, the imaging apparatus 10 has been described as including the two antennas 31 and 32, but an imaging apparatus may include three or more antennas.

In addition, in the embodiment, the imaging apparatus 10 uses the memory card 22 as a recording medium for recording image data, but a recording medium other than the memory card may be used. For example, as will be described later, an external recording apparatus may be used.

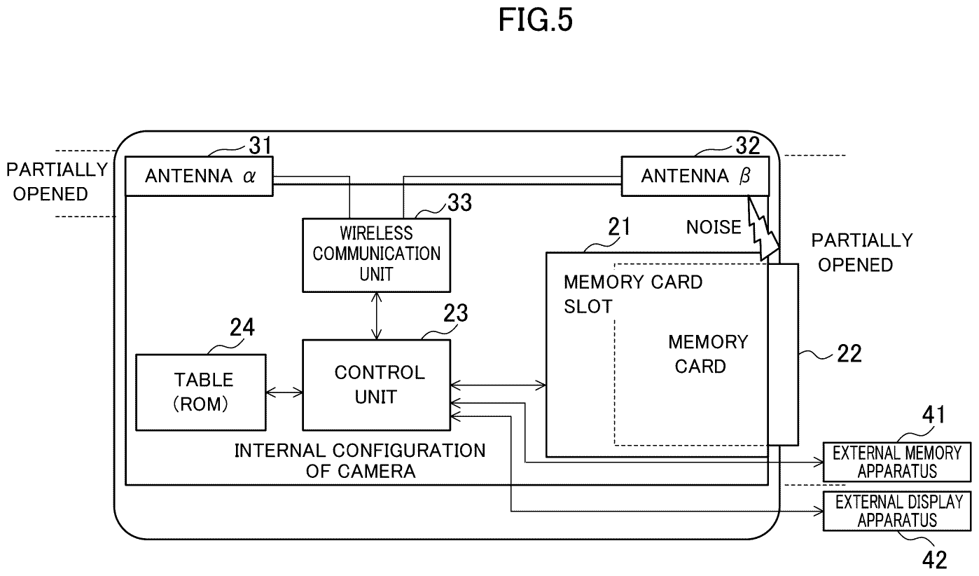

FIG. 5 is another example of an internal configuration of an imaging apparatus. In FIG. 5, the imaging apparatus can be connected to an external memory apparatus 41 or an external display apparatus 42 as an external apparatus. The external memory apparatus 41 is, for example, an external solid state drive (SSD), and is connected to the imaging apparatus via, for example, a universal serial bus (USB) port. The external display apparatus 42 is, for example, an external liquid crystal display apparatus, and is connected to the imaging apparatus via, for example, a high-definition multimedia interface (HDMI, registered trademark) port.

In the configuration of FIG. 5, noise may be generated with respect to wireless communication at the time of accessing the external memory apparatus 41 or the external display apparatus 42. Therefore, in the configuration of FIG. 5, a table 24 stores, as antenna setting information, a relationship between category information of the external memory apparatus 41 and the external display apparatus 42 and setting information of a valid antenna used when the external memory apparatus 41 and the external display apparatus 42 are connected. A controller 23 selects an antenna to be used by referring to the antenna setting information stored in the table 24 and using the category information of the connected external memory apparatus 41. Alternatively, the controller 23 selects an antenna to be used by referring to the antenna setting information stored in the table 24 and using the category information of the connected external display apparatus 42.

Furthermore, in the configuration of FIG. 5, the controller 23 may select an antenna to be used by using information of whether the external display apparatus 42 is connected as information of an operation mode.

In the above embodiment, it has been described that the memory card information includes four pieces of information of the manufacturer category, and the name, the type, and the capacity representing the device category, but one piece of unique information may be used as the memory card information as long as the category information of the memory card can be collected.

In addition, in the above embodiment, the digital camera that is not a lens interchangeable type has been described as an example of the imaging apparatus, but the imaging apparatus of the present embodiment may be a digital camera that is a lens interchangeable type.

The functions realized by the components described herein may be implemented in circuitry or processing circuitry, including a general purpose processor, an application specific processor, an integrated circuit, application specific integrated circuits (ASICs), a central processing unit (CPU), a conventional circuit, and/or combinations thereof programmed to realize the described functions. The processor includes a transistor and other circuits, and is regarded as circuitry or processing circuitry. The processor may be a programmed processor configured to execute a program stored in a memory.

In this specification, the circuitry and the units are hardware programmed to implement the described functions or hardware executing the described functions. The hardware may be any hardware disclosed herein or any hardware programmed or known to execute the described functions.

In a case where the hardware is a processor regarded as a type of circuitry, the circuitry or the unit is a combination of hardware and software used to configure the hardware and/or the processor.

As described above, the embodiments have been described as examples of the technique in the present disclosure. For this purpose, the accompanying drawings and the detailed description have been provided.

Therefore, the components described in the accompanying drawings and the detailed description may include not only components essential for solving the problem but also components that are not essential for solving the problem in order to exemplify the above technique. Therefore, it should not be immediately recognized that these non-essential components are essential based on the fact that these non-essential components are described in the accompanying drawings and the detailed description.

In addition, since the above embodiments are intended to exemplify the technique in the present disclosure, various changes, replacements, additions, omissions, and the like can be made within the scope of the claims or equivalents thereof.

The present disclosure can be applied not only to a digital camera but also to a movie camera as an imaging apparatus having a wireless communication function and including a slot that can be loaded with a recording medium, and can also be applied to an electronic device having an imaging function such as a personal computer (PC).

What is claimed is:

1. An imaging apparatus comprising:
a plurality of antennas;
a wireless communication unit configured to perform wireless communication by using the plurality of antennas;
an imaging sensor configured to capture a subject image to generate image data;
a slot into which a recording medium for recording the image data is insertable;
a memory configured to store antenna setting information indicating a combination of category information of the recording medium and an antenna to be used; and
a controller configured to perform control including wireless communication by the wireless communication unit and access to the recording medium inserted into the slot, wherein
in a case of performing wireless communication by the wireless communication unit and accessing the recording medium inserted into the slot,
the controller selects an antenna to be used from the plurality of antennas by referring to the antenna setting information stored in the memory and using the category information of the recording medium inserted into the slot, and
accesses the recording medium while performing wireless communication by the wireless communication unit by using the selected antenna.

2. The imaging apparatus according to claim 1, wherein
the plurality of antennas includes a first antenna and a second antenna,
a distance between the first antenna and the slot is larger than a distance between the second antenna and the slot, and
when one antenna is used from the plurality of antennas, the antenna setting information stored in the memory specifies to use the first antenna.

3. The imaging apparatus according to claim 1, wherein the antenna setting information sets an antenna to be used according to magnitude of electromagnetic noise generated by the recording medium.

4. The imaging apparatus according to claim 1, wherein the controller selects an antenna to be used by using information of an operation mode of the imaging apparatus in addition to the category information of the recording medium inserted into the slot.

5. The imaging apparatus according to claim 1, further comprising
a casing, wherein
the plurality of antennas includes a first antenna and a second antenna,
the casing has a rectangular shape as viewed in a normal direction of a light receiving surface of the imaging sensor, and
in the casing, as viewed in the normal direction of the light receiving surface of the imaging sensor, the first antenna is arranged on one end side and the second antenna is arranged on another end side, in a longitudinal direction of the rectangular shape.

6. The imaging apparatus according to claim 1, wherein wireless communication using the plurality of antennas is multi input multi output (MIMO) communication.

7. The imaging apparatus according to claim 1, wherein the antenna setting information stored in the memory can be updated by wireless communication from an outside of the imaging apparatus.

8. The imaging apparatus according to claim 1, further comprising
a casing made of metal, wherein
in the casing, portions where the plurality of antennas and the slot are arranged are opened.

9. An imaging apparatus comprising:
a plurality of antennas;
a wireless communication unit configured to perform wireless communication by using the plurality of antennas;
an imaging sensor configured to capture a subject image to generate image data;
a port to which an external apparatus is connectable;
a memory configured to store antenna setting information indicating a combination of category information of the external apparatus and an antenna to be used; and
a controller configured to perform control including wireless communication by the wireless communication unit and access to the external apparatus connected to the port, wherein
in a case of performing wireless communication by the wireless communication unit and accessing the external apparatus connected to the port,
the controller selects an antenna to be used from the plurality of antennas by referring to the antenna setting information stored in the memory and using the category information of the external apparatus connected to the port, and
accesses the external apparatus while performing wireless communication by the wireless communication unit by using the selected antenna.
